(19) United States
(12) Patent Application Publication
(10) Pub. No.: US 2011/0143078 A1
(43) Pub. Date: Jun. 16, 2011

(54) Polymer Pin Type Insulator And Method Of Manufacturing The Same

(75) Inventors: Se-young JUNG, Busan (KR); Choon-hyun Park, Gimhae-si (KR)

(73) Assignee: DTR Co., Ltd. (Status: Corporation or Organization ), Jinju-si (KR)

(21) Appl. No.: 12/756,907

(22) Filed: Apr. 8, 2010

(30) Foreign Application Priority Data
Dec. 16, 2009 (KR) 10-2009-0125371

(51) Int. Cl. B32B 3/02; B29C 45/14

(52) U.S. Cl. 428/68; 264/135

(57) ABSTRACT

The present invention provides a polymer pin type insulator made of a polymer material and a method of manufacturing the same. The method of manufacturing a polymer pin type insulator, includes the steps of: forming an inner core which is made of an insulating material and has a threaded hole engaged with a pin coupled with a steel cross-arm or a wooden crossbar of an electric pole; sanding the inner core using a sanding solution to enlarge a surface area of the inner core; applying an adhesive onto the inner core; and forming a polymer housing, which constitutes an outer appearance of the polymer pin type insulator and is provided with an electric wire support groove at an upper portion thereof, by vacuum-injecting a polymer material onto the inner core. The method of manufacturing a polymer pin type insulator is advantageous in that the design of a pin type insulator can be very easily modified depending on the requirements of users and the use conditions of the pin type insulator. Further, the polymer pin type insulator is advantageous in that it can be sufficiently used even at high pressure, can be easily transported and installed, can prevent accidents and can enjoy an increased lifespan.

### REFERENCE TO RELATED APPLICATIONS

This application claims the priority benefit of Korean Patent Application No. 10-2009-0125371 filed on Dec. 16, 2009, the entire contents of which are incorporated herein by reference.

### FIELD OF THE INVENTION

The present invention relates to a pin type insulator, and, more particularly, to a polymer pin type insulator made of a polymer material and a method of manufacturing the same.

### BACKGROUND OF THE INVENTION

Generally, pin type insulators are used in overhead power distribution lines of 11.5 kV˜69 kV, and are used to support and insulate electric wires, such as overhead ground wires and the like.

FIG. 1 is a front view showing a conventional pin type insulator.

As shown in FIG. 1, a conventional pin type insulator 100 is made of a porcelain material, and includes an electric wire support groove 110 which supports an electric wire, such as an overhead ground wire or the like, and is formed at the upper portion thereof and a threaded hole 120 which is engaged with a pin coupled with a steel cross-arm and a wooden crossbar of an electric pole and is formed in the lower portion thereof.

Since a conventional pin type insulator is made of a porcelain material, its electrical characteristics with respect to the environment are not excellent, thus gradually decreasing the use frequency thereof at high pressure.

Meanwhile, conventional pin type insulators are problematic in that they are heavy and in that they are easily damaged during their transportation or installation. Further, conventional pin type insulators are problematic in that their surfaces are easily contaminated according to changes in the environment and in that they have very low tracking resistance, arc resistance and puncture voltage and the like, thus increasing accidents and shortening the lifespan.

### SUMMARY OF THE INVENTION

Accordingly, the present invention has been devised to solve the above problems, and an object of the present invention is to provide a polymer pin type insulator which can be sufficiently used even at high pressure, can be easily transported and installed, can prevent accidents and can enjoy an increased lifespan, and a method of manufacturing the same.

In order to accomplish the above object, an aspect of the present invention provides a method of manufacturing a polymer pin type insulator, including the steps of: forming an inner core which is made of an insulating material and has a threaded hole engaged with a pin coupled with a steel cross-arm or a wooden crossbar of an electric pole; sanding the inner core using a sanding solution to enlarge a surface area of the inner core; applying an adhesive onto the inner core; and forming a polymer housing, which constitutes an outer appearance of the polymer pin type insulator and is provided with an electric wire support groove at an upper portion thereof, by vacuum-injecting a polymer material onto the inner core.

In the method, the inner core may be made of one or more insulating materials selected from among BMC, SMC, PET, FRP, PBT, ABS, fine ceramics, and nylon 66 containing 30% glass fiber (GF).

Further, the polymer housing may be made of one or more polymer materials selected from among silicon, EPDM and mixtures thereof.

Further, the polymer housing may be formed to have a bell shape which is curved downward from the electric wire support groove.

Further, the polymer housing may be formed to have a cylindrical shape in which a diameter changes downward from the electric wire support groove.

Further, the sanding solution may include aluminum oxide (Al₂O₃) balls.

Another aspect of the present invention provides a polymer pin type insulator, including: a polymer housing which is made of a polymer material, which constitutes an outer appearance of the polymer pin type insulator and which is provided with an electric wire support groove at an upper portion thereof; and an inner core which is made of an insulating material and has a threaded hole engaged with a pin coupled with a steel cross-arm or a wooden crossbar of an electric pole.

In the polymer pin type insulator, the polymer housing may be made of one or more polymer materials selected from among silicon, EPDM and mixtures thereof.

Further, the inner core may be made of one or more insulating materials selected from among BMC, SMC, PET, FRP, PBT, ABS, fine ceramics, and nylon 66 containing 30% glass fiber (GF).

Further, the polymer housing may be formed to have a bell shape which curves downward from the electric wire support groove.

Further, the polymer housing may be formed to have a cylindrical shape in which a diameter changes downward from the electric wire support groove.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a front view showing a conventional pin type insulator;

FIG. 2 is a front view showing a polymer pin type insulator according to an embodiment of the present invention;

FIG. 3 is a perspective view showing a polymer pin type insulator viewed from above according to an embodiment of the present invention;

FIG. 4 is a perspective view showing a polymer pin type insulator viewed from below according to an embodiment of the present invention;

FIG. 5 is a perspective view showing an inner core of the polymer pin type insulator according to an embodiment of the present invention;

FIG. 6 is a perspective view showing an electric pole provided with the polymer pin type insulator according to an embodiment of the present invention;

FIGS. 7A and 7B are views showing modified polymer pin type insulators according to an embodiment of the present invention; and

FIG. 8 is a flowchart showing a method of manufacturing a polymer pin type insulator according to an embodiment of the present invention.

### DETAILED DESCRIPTION OF THE INVENTION

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted.

Hereinafter, preferred embodiments of the present invention will be described in detail with reference to the attached drawings.

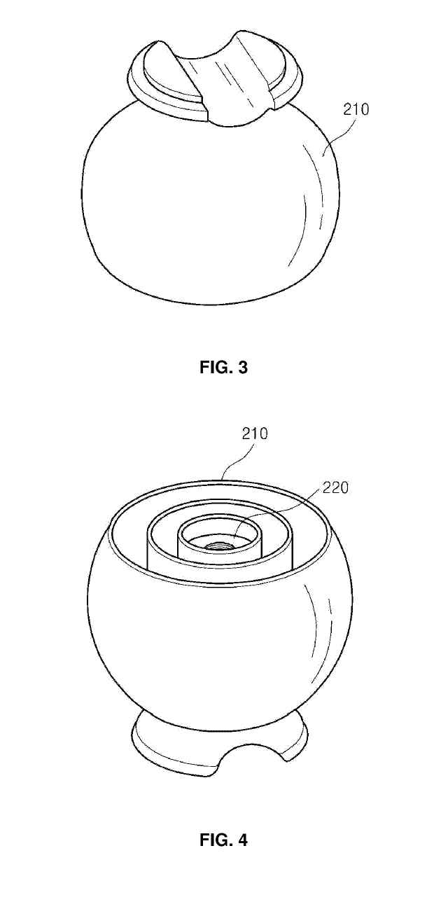

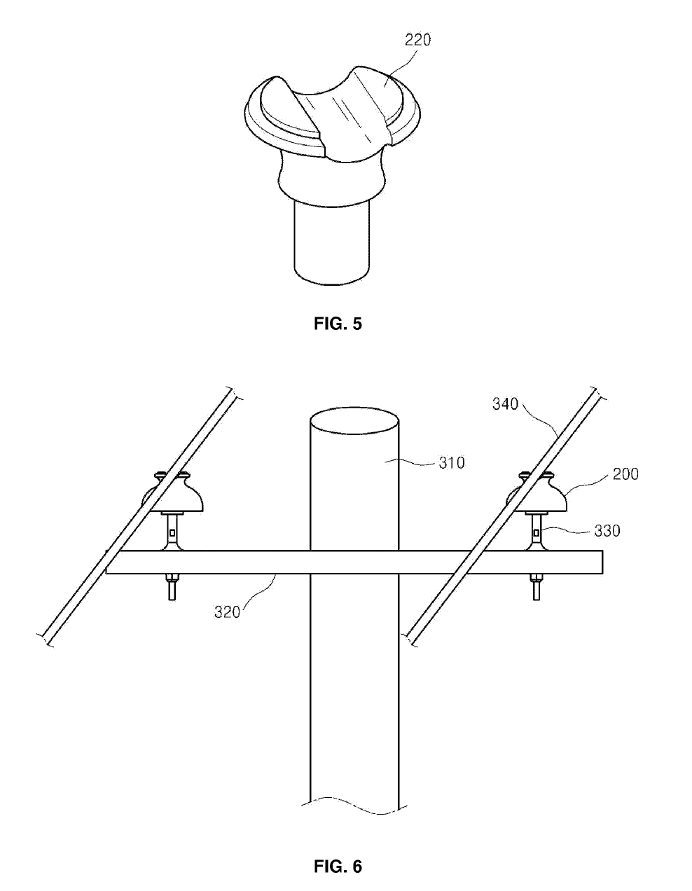

FIGS. 2 to 5 are views explaining a polymer pin type insulator according to an embodiment of the present invention. Concretely, FIG. 2 is a front view showing a polymer pin type insulator according to an embodiment of the present invention, FIG. 3 is a perspective view showing a polymer pin type insulator viewed from above according to an embodiment of the present invention, FIG. 4 is a perspective view showing a polymer pin type insulator viewed from below according to an embodiment of the present invention, and FIG. 5 is a perspective view showing an inner core of the polymer pin type insulator according to an embodiment of the present invention.

As shown in FIGS. 2 to 5, a polymer pin type insulator 200 according to an embodiment of the present invention, which is a pin type insulator made of a polymer material and having no clamp at the upper portion thereof, is used in overhead power distribution lines of 11.5 kV˜69 kV, and are used to support and insulate electric wires, such as overhead ground wires and the like. The polymer pin type insulator 200 according to an embodiment of the present invention includes a polymer housing 210 and an inner core 220.

The polymer housing 210 is made of a polymer material, and is provided with an electric wire support groove 211 at the upper portion thereof.

The polymer material, compared to a porcelain material, is light and flexible, is easily machined, and has very excellent tracking resistance, weather resistance, arc resistance, puncture voltage and water repellency. Therefore, it is preferred that the polymer housing 210 be made of any one of silicon, EPDM (ethylene propylene diene monomer) and mixtures thereof.

The electric wire support groove 211, which is a semicircular recess formed at the upper portion of the polymer housing 210, is configured such that an electric wire, such as an overhead ground wire or the like, is fixed on the electric wire support groove 211 by disposing and binding the electric wire thereon.

Meanwhile, the polymer housing 210 has a bell-shaped appearance which is downwardly-curved from the electric wire support groove 211. This polymer housing 210 having a bell-shaped appearance is designed in consideration of surface leakage distance, dry surface flashover distance and the like, and the design of the polymer housing 210 can be very easily modified depending on the requirements of users and the use conditions of the pin type insulator.

The inner core 220, which is made of an insulating material, is formed in the polymer housing 210, and has a threaded hole 221 which is engaged with a pin coupled with a steel cross-arm or a wooden crossbar of an electric pole.

The inner core 220 may be made of one or more insulating materials having flame retardance, weather resistance and electrical insulation properties selected from among BMC (bulk molding compound), SMC (sheet molding compound), PET (polyethylen terephthalate), FRP (fiber reinforced plastics), PBT (polybutylene terephthalate), ABS (acrylonitrile butadiene styrene), fine ceramics and nylon 66 containing 30% glass fiber (GF). Further, the inner core 220 is required to have excellent mechanical properties related to the warp, twist and tensile load generated from the external in addition to the above properties. Among the insulating materials, nylon 66 glass fiber has the most excellent mechanical properties.

As described above, since the polymer pin type insulator according to an embodiment of the present invention includes a polymer housing 210 which is made of a polymer material and an inner core 220 which is made of an insulating material having excellent mechanical properties and is formed in the polymer housing 210, this polymer pin type insulator can be sufficiently used even at high pressure, can be easily transported and installed, and can prevent accidents and can enjoy an increased lifespan.

FIG. 6 is a perspective view showing an electric pole provided with a polymer pin type insulator according to an embodiment of the present invention.

As shown in FIG. 6, an electric pole 310 is provided with a steel cross-arm or wooden crossbar 320, pins 330 and polymer pin type insulators 200 in order to easily insulate and install a plurality of electric wires 340.

Concretely, the steel cross-arm or wooden crossbar 320 is horizontally disposed across the electric pole 310, and serves as a base for setting the pins 330. The pins 330 are driven into the steel cross-arm or wooden crossbar 320. The polymer pin type insulator 200 according to an embodiment of the present invention is connected to the upper portion of the pin 330 by engaging the pin 330 with the threaded hole 221 formed in the polymer pin type insulator 200. The electric wires 340, such as overhead ground wires and the like, are fixed on the concave electric wire support groove 211 formed at the upper portion of the polymer pin type insulator 200 using a binder.

For this reason, the polymer pin type insulator 200 according to an embodiment of the present invention, which is a pin type insulator made of a polymer material and having no clamp at the upper portion thereof, can be used in overhead power distribution lines of 11.5 kV˜69 kV, and can be used to support and insulate the electric wires, such as overhead ground wires and the like.

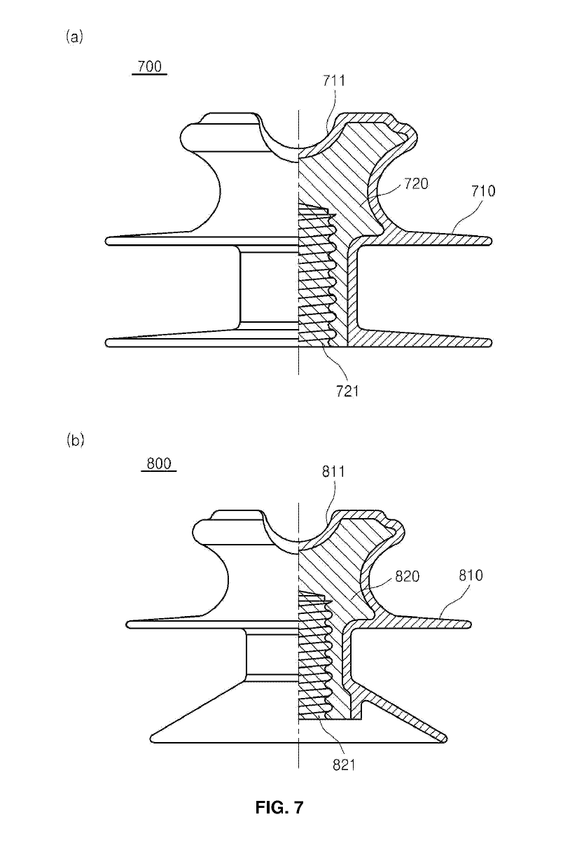

FIGS. 7A and 7B are views showing modified polymer pin type insulators according to an embodiment of the present invention.

As shown in FIGS. 7A and 7B, the modified polymer pin type insulators 700 and 800 according to an embodiment of the present invention include polymer housings 710 and 810, each having a cylindrical shape in which its diameter changes downward from its electric wire support groove 711 or 811. Here, the shapes of the polymer housings 710 and 780 are changed in order to provide the electrical and mechanical properties necessary for the polymer pin type insulators 700 and 800.

As such, when the polymer pin type insulator requires more excellent electrical and mechanical characteristics, it is possible to change the shapes of the polymer pin type insulators 700 and 800 in various forms if necessary as shown in FIGS. 7A and 7B because they have excellent formability. In particular, since the polymer pin type insulators 700 and 800 can be freely formed such that they have a cylindrical shape in which its diameter changes downward from its electric wire support groove 711 or 811, that is, a wing shape, they can exhibit more excellent electrical properties (for example, higher brain impulse flashover voltages) and larger leakage distance and flashover distance. Meanwhile, the inner cores 720 and 820 are the same as or similar to the above-mentioned core 220, and are formed therein with threaded holes 721 and 821.

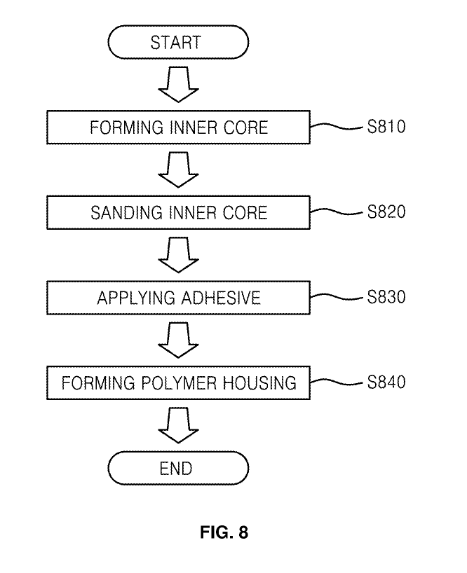

FIG. 8 is a flowchart showing a method of manufacturing a polymer pin type insulator according to an embodiment of the present invention.

As shown in FIG. 8, the method of manufacturing a polymer pin type insulator according to an embodiment of the present invention includes the following steps.

First, in the step of forming an inner core (S810), an inner core, which is made of an insulating material and has a threaded hole engaged with a pin coupled with a steel cross-arm or a wooden crossbar of an electric pole, is formed. In this case, the inner core may be made of one or more insulating materials selected from among BMC, SMC, PET, FRP, PBT, ABS, fine ceramics, and nylon 66 containing 30% glass fiber (GF).

Subsequently, in the step of sanding the inner core (S820), the inner core is sanded using a sanding solution to enlarge its surface area. The sanding solution, which includes aluminum oxide (Al₂O₃) balls, roughens the surface of the inner core to enlarge the surface area of the inner core. Since the surface area of the inner core is enlarged, the contact areas between the inner core and the polymer housing to be formed in a subsequent step can also be enlarged. After the sanding, the sanding solution adsorbed on the inner core is washed.

Subsequently, in the step of applying an adhesive (S830), an adhesive is applied onto the inner core. The adhesive is a material helping the inner core to easily adhere to a polymer housing to be formed in a subsequent step. After applying the adhesive to the inner core, the inner core is dried.

Subsequently, in the step of forming a polymer housing (S840), a polymer housing, which constitutes the outer appearance of a polymer pin type insulator and is provided with an electric wire support groove at the upper portion thereof, is formed by vacuum-injecting a polymer material onto the inner core. Concretely, an injection molding machine is mounted with a mold, the inner core is inserted into the mold, and then the polymer material is vacuum-injected onto the inner core to complete a polymer pin type insulator.

In this case, the polymer housing may be made of one or more polymer materials selected from among silicon, EPDM and mixtures thereof. Further, the polymer housing may be formed to have a bell shape which is curved downward from its electric wire support groove or a cylindrical shape in which its diameter changes downward from its electric wire support groove.

Finally, the appearance and bending load of the completed polymer pin type insulator are inspected.

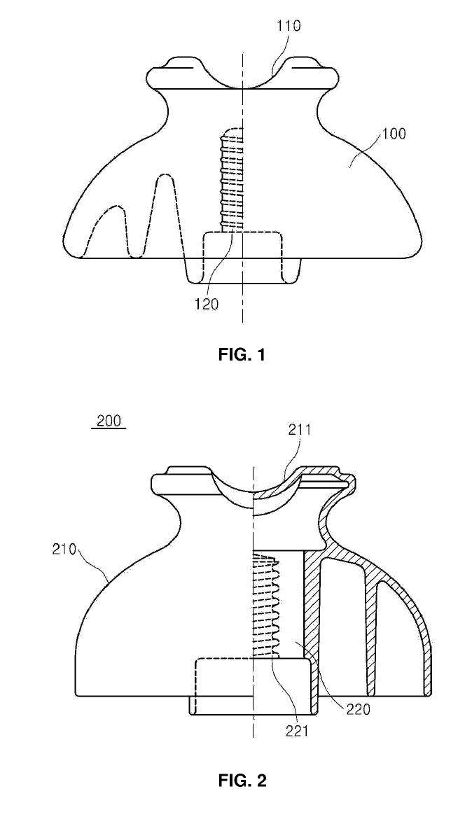

The more detailed description of the method of manufacturing a polymer pin type insulator according to the present invention is replaced by the above description of the polymer pin type insulator according to an embodiment of the present invention explained with reference to FIGS. 1 to 7, because the detailed description of this method is the same as or similar to the above description of the polymer pin type insulator.

Therefore, the polymer pin type insulator of the present invention can be sufficiently used even at high pressure, can be easily transported and installed, can prevent accidents and can enjoy an increased lifespan. Further, in the method of manufacturing the polymer pin type insulator of the present invention, the design of a pin type insulator can be very easily modified depending on the requirements of users and the use conditions of the pin type insulator.

As described above, the polymer pin type insulator according to the present invention is advantageous in that it can be sufficiently used even at high pressure, can be easily transported and installed, can prevent accidents and can enjoy an increased lifespan.

Further, the method of manufacturing a polymer pin type insulator according to the present invention is advantageous in that the design of a pin type insulator can be very easily modified depending on the requirements of users and the use conditions of the pin type insulator.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A method of manufacturing a polymer pin type insulator, comprising the steps of:
forming an inner core which is made of an insulating material and has a threaded hole engaged with a pin coupled with a steel cross-arm or a wooden crossbar of an electric pole;
sanding the inner core using a sanding solution to enlarge a surface area of the inner core;
applying an adhesive onto the inner core; and
forming a polymer housing, which constitutes an outer appearance of the polymer pin type insulator and is provided with an electric wire support groove at an upper portion thereof, by vacuum-injecting a polymer material onto the inner core.

2. The method of manufacturing a polymer pin type insulator according to claim 1, wherein the inner core is made of one or more insulating materials selected from among BMC, SMC, PET, FRP, PBT, ABS, fine ceramics, and nylon 66 containing 30% glass fiber (GF).

3. The method of manufacturing a polymer pin type insulator according to claim 1, wherein the polymer housing is made of one or more polymer materials selected from among silicon, EPDM and mixtures thereof.

4. The method of manufacturing a polymer pin type insulator according to claim 1, wherein the polymer housing is formed to have a bell shape which curves downward from the electric wire support groove.

5. The method of manufacturing a polymer pin type insulator according to claim 1, wherein the polymer housing is formed to have a cylindrical shape in which a diameter changes downward from the electric wire support groove.

6. The method of manufacturing a polymer pin type insulator according to claim 1, wherein the sanding solution includes aluminum oxide (Al₂O₃) balls.

7. A polymer pin type insulator, comprising:
a polymer housing which is made of a polymer material, which constitutes an outer appearance of the polymer pin type insulator and which is provided with an electric wire support groove at an upper portion thereof; and
an inner core which is made of an insulating material and has a threaded hole engaged with a pin coupled with a steel cross-arm or a wooden crossbar of an electric pole.

8. The polymer pin type insulator according to claim 7, wherein the polymer housing is made of one or more polymer materials selected from among silicon, EPDM and mixtures thereof.

9. The polymer pin type insulator according to claim 7, wherein the inner core is made of one or more insulating materials selected from among BMC, SMC, PET, FRP, PBT, ABS, fine ceramics, and nylon 66 containing 30% glass fiber (GF).

10. The polymer pin type insulator according to claim 7, wherein the polymer housing is formed to have a bell shape which curves downward from the electric wire support groove.

11. The polymer pin type insulator according to claim 7, wherein the polymer housing is formed to have a cylindrical shape in which a diameter changes downward from the electric wire support groove.
